(19) United States
(12) Patent Application Publication
(10) Pub. No.: US 2024/0418608 A1
(43) Pub. Date: Dec. 19, 2024

(54) SYSTEM RESPONSE TEST FOR AN ELECTROMECHANICAL ACTUATOR SYSTEM

(71) Applicant: JAGUAR LAND ROVER LIMITED, Warwickshire (GB)

(72) Inventors: Adrian Bouaru, Whitley, Coventry, Warwickshire (GB); Thomas Papanikolaou, Whitley, Coventry, Warwickshire (GB)

(21) Appl. No.: 18/702,473

(22) PCT Filed: Oct. 18, 2021
(86) PCT No.: PCT/EP2021/078797

§ 371 Date: Apr. 18, 2024

(51) Int. Cl. G01M 17/04

(52) U.S. Cl. CPC G01M 17/04

(57) ABSTRACT

Aspects of the present invention relate to a diagnostic apparatus (100) for use in testing an electromechanical actuator system of a vehicle (500). The diagnostic apparatus comprises one or more controllers (110), and the diagnostic apparatus configured to: generate a torque demand signal (155) corresponding to a torque demand profile (300), the torque demand profile configured to cause actuators of the electromechanical actuator system to modify a suspension of the vehicle (402); transmit the torque demand signal to the electromechanical actuator system of the vehicle (404); record a suspension characteristic of the vehicle in response to application of the torque demand signal (406); and output the recorded suspension characteristic of the vehicle (408).

### TECHNICAL FIELD

The present disclosure relates to a system response test for an electromechanical actuator system. Aspects of the invention relate to a diagnostic apparatus, to a system, to a vehicle, to a method, and to a computer software, for testing a system response of an electromechanical actuator system.

### BACKGROUND

Vehicles (for example petrol, diesel, electric or hybrid vehicles) comprise active suspension systems, such as an electronic active roll control system, for maintaining vehicle stability. Such electronic active roll control systems comprise at least one actuator, the actuator being configured so as to actively impart motor control on the suspension system, the at least one actuator being coupled to a roll bar.

Such active suspension systems may include a number of individual subcomponents or mechatronic subsystems. There may be a high level vehicle control generating a system demand signal, for example a torque demand signal, to influence vehicle motion. There may be a low level controller providing control signals to an actuator (for example to provide motor control) of the active suspension system, to deliver the demanded signal provided. There may be associated mechanical or electromechanical components to deliver a physical manifestation of the demanded signal, for example a motor. There may be a dedicated power supply system. There may be significant interaction between these subsystems in order to provide operation of the active suspension system.

Due to the interaction between components and subsystems, identifying a cause of a problem or fault within the active suspension system can prove challenging. In particular, once the vehicle has been built (i.e. is no longer in a manufacturing facility) there may be few or no means by which a user in a service environment can diagnose an issue with the active suspension system. A tool to enable investigation of causes of problems arising from the active suspension system is therefore desirable.

It is an aim of the present invention to address one or more of the disadvantages associated with the prior art.

### SUMMARY OF THE INVENTION

Aspects and embodiments of the invention provide a diagnostic apparatus, a system, a vehicle, a method, and a computer software as claimed in the appended claims.

According to an aspect of the present invention, there is provided a diagnostic apparatus for use in testing an electromechanical actuator system of a vehicle, the diagnostic apparatus comprising one or more controllers, the diagnostic apparatus configured to: generate a torque demand signal corresponding to a torque demand profile, the torque demand profile configured to cause actuators of the electromechanical actuator system to modify a suspension of the vehicle; transmit the torque demand signal to the electromechanical actuator system of the vehicle; record a suspension characteristic of the vehicle in response to application of the torque demand signal; and output the recorded suspension characteristic of the vehicle.

The torque demand profile may comprise: a positive torque and a negative torque within first torque limits; and a positive torque and a negative torque within second torque limits.

The second torque limits may be at a higher torque than the first torque limits.

The torque demand profile may comprise one or more of: a steady increase in torque to a positive torque limit; a constant torque at the positive torque limit; a steady decrease in torque to zero; a steady decrease in torque to a negative torque limit; a constant torque at the negative torque limit; and a steady increase in torque to zero.

The torque demand profile may comprise one or more of: a controlled zero torque; a steady increase in torque to a positive torque limit; a constant torque at the positive torque limit; a steady decrease in torque to zero; a controlled zero torque; a steady decrease in torque to a negative torque limit; a constant torque at the negative torque limit; a steady increase in torque to zero; and a controlled zero torque.

Recording the suspension characteristic of the vehicle may comprise monitoring one or more of: a symmetry of deflection of the suspension at both sides of the vehicle; a roll angle of the vehicle; an amount of lean of the vehicle; and a lateral acceleration of the vehicle.

The invention apparatus may be configured to: record one or more characteristics of the electromechanical actuator system; and output the recorded one or more characteristics of the electromechanical actuator system.

Recording one or more characteristics of the electromechanical actuator system may comprise receiving one or more of: a time taken for torque to reach a demanded torque level; and a physical rotation of a motor of the electromechanical actuator system.

Recording one or more characteristics of the electromechanical actuator system may comprise receiving one or more of a current and voltage applied to the electromechanical actuator system to achieve the torque demand profile.

The diagnostic apparatus may be configured to, prior to transmitting the torque demand signal, verify that one or more safety preconditions are met.

Verifying that the one or more safety preconditions are met may comprise one or more of: ensuring that a system automotive safety integrity level, ASIL, is maintained; verifying that the vehicle is in a stationary state; verifying that there are no fault conditions in the vehicle; and verifying if a provided security credential meets a security authorisation level. The fault condition may be a fault condition relating to the electromechanical actuator system.

Verifying that the vehicle is in a stationary state may comprise one or more of: verifying that the vehicle is not moving, verifying that an engine of the vehicle is not active, verifying that the vehicle is not in gear, and verifying that a parking brake of the vehicle is enabled.

Verifying that there are no fault conditions in the vehicle, in particular fault conditions relating to the electromechanical actuator system, may comprise one or more of: checking a log to see if a fault condition has been recorded, and running one or more tests to check if a fault condition is returned. Running one or more tests to check if a fault condition is returned may comprise checking a current value of one or more signals available to the diagnostic apparatus.

Verifying that the one or more safety preconditions are met may comprise verifying if a provided security credential meets a security authorisation level.

The provided security credential may be one or more of: a chassis control module security credential, and a toolset security credential.

The diagnostic apparatus may be configured to: identify that a recorded characteristic of the electromechanical actuator is outside of a predetermined range; and output a fault indication.

The diagnostic apparatus may be configured to stop application of the torque demand signal to the electromechanical actuator system if an actual test duration exceeds an expected time period.

According to another aspect of the invention, there is provided a system comprising the diagnostic apparatus as disclosed herein, and the electromechanical actuator system of the vehicle.

According to yet another aspect of the invention, there is provided a vehicle comprising a diagnostic apparatus as disclosed herein, or a system as disclosed herein.

According to a further aspect of the invention, there is provided a method comprising: generating a torque demand signal corresponding to a torque demand profile, the torque demand profile configured to cause actuators of an electromechanical actuator system of a vehicle to modify a suspension of the vehicle; transmitting the torque demand signal to the electromechanical actuator system of the vehicle; recording a suspension characteristic of the vehicle in response to application of the torque demand signal; and outputting the recorded suspension characteristic of the vehicle.

According to a still further aspect of the invention, there is provided computer readable instructions which, when executed by a computer, are arranged to perform a method as disclosed herein.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a controller of a diagnostic apparatus according to examples disclosed herein;

FIG. 2a shows a control system for a vehicle connected to front and rear anti-roll bars according to examples disclosed herein;

FIG. 2b shows a control system for a vehicle comprising plural sub-systems, and front and rear anti-roll bars according to examples disclosed herein;

FIG. 3 shows an example torque demand profile according to examples disclosed herein;

FIG. 4 shows an example method according to examples disclosed herein; and

FIG. 5 shows a vehicle in accordance with an embodiment of the invention.

### DETAILED DESCRIPTION

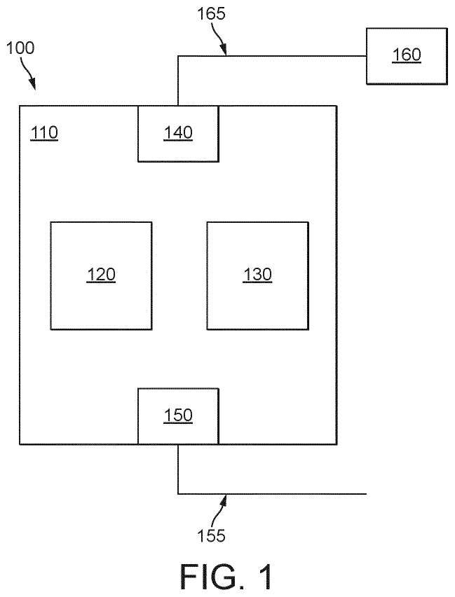

With reference to FIG. 1, there is illustrated a control system 100 for a diagnostic apparatus for a vehicle. The control system 100 comprises one or more controllers 110. The control system 100 as illustrated in FIG. 1 comprises one controller 110, although it will be appreciated that this is merely illustrative. The controller 110 comprises processing means 120 and memory means 130. The processing means 120 may be one or more electronic processing device 120 which operably executes computer-readable instructions. The memory means 130 may be one or more memory device 130. The memory means 130 is electrically coupled to the processing means 120. The memory means 130 is configured to store instructions, and the processing means 120 is configured to access the memory means 130 and execute the instructions stored thereon.

The controller 110 comprises an input means 140 and an output means 150. The input means 140 may comprise an electrical input 140 of the controller 110. The output means 150 may comprise an electrical output 150 of the controller 100. The input 140 may be arranged to receive a suspension characteristic signal 165 from one or more sensors 160 of the vehicle. The inputs may be either physical (for example from a hard wired sensor) and/or may be from a vehicle communication bus. The input 140 may be arranged to additionally receive combined sensor or communication data from multiple sensors or other controller units. The suspension characteristic signal 165 is an electrical signal which is indicative of one or more characteristics of a suspension system of the vehicle. For example, the suspension characteristic signal may be indicative of a symmetry of deflection of the suspension at both sides of the vehicle, a roll angle of the vehicle, an amount of lean of the vehicle, or a lateral acceleration of the vehicle. The output 150 is arranged to output a torque demand signal 155 for controlling one or more actuators of an electromechanical actuator system of the vehicle. In some examples, a measurement of vehicle roll rate may be received from a sensor connected to the controller 110 via a vehicle communication bus. In some examples, a measurement of suspension height at each corner of the vehicle may be received as a voltage reading from a hardwired sensor. In some examples, a measurement of vehicle speed may be received from an additional controller in the vehicle, via a vehicle communication bus. In some examples, a measured torque and actuator motor position may be received from one or more anti-roll bar controllers, connected to the controller 110 via a vehicle communications bus.

By outputting a torque demand signal 155 and applying said torque demand signal to one or more actuators of the electromechanical actuator system of the vehicle, a response of the vehicle due to the application of the torque demand signal can be recorded using the one or more sensors 160 of the vehicle. The torque demand signal 155 is configured to cause the one or more actuators of the electromechanical actuator system to modify a suspension of the vehicle.

The electromechanical actuator system may be any of an active suspension system, an anti-roll control system, or other similar systems which effect one or more performance characteristics of the vehicle. The actuator may be an actuator associated with an active roll control system, wherein the active roll control system may form part of the suspension system. The actuator may be a rotary actuator. The actuator may include one or more gears or a gearbox.

The diagnostic apparatus described herein may be implemented as an external device which can be communicatively connected to the vehicle by either a physical connector or wirelessly. Alternatively, the diagnostic apparatus may be implemented by one or more dedicated controllers within the vehicle. Alternatively, the diagnostic apparatus may be implemented in software on one or more general purpose controllers within the vehicle, for example a controller of a chassis control module. In some examples, a combination of the above implementations may be used.

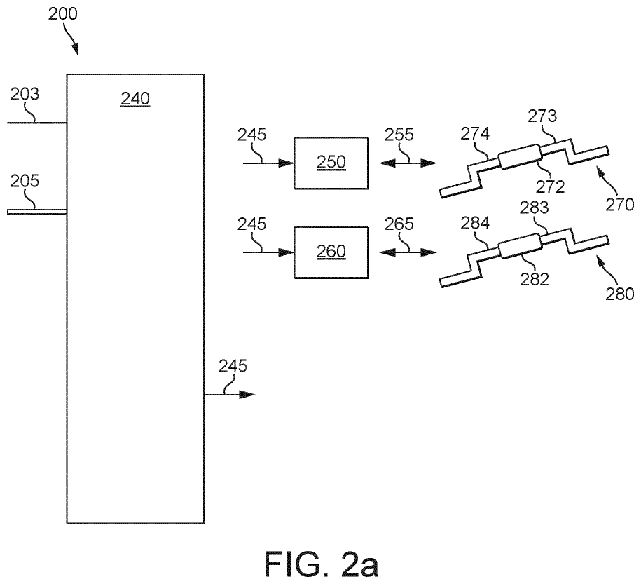

FIGS. 2a and 2b illustrate example control system 200 for a suspension system of a vehicle. A suspension system of a vehicle may comprise anti-roll bars 270, 280 which are controlled using an anti-roll control system. The anti-roll control system acts to control the anti-roll bars, to control a roll of a body of the vehicle and reduce the impact of disturbances from a road surface. The anti-roll control system may be electromechanical and/or hydraulic. Anti-roll bars 270, 280 may typically comprise stabiliser bars, typically metal, which join the vehicle suspension on either side of the vehicle axle, usually through drop links, and connect to a rotational actuator situated between the mounting points to the vehicle chassis. Each side of the anti-roll bar is able to rotate freely when a motor of the anti-roll control system is not energised. When the motor control is enabled (i.e. delivering torque), the anti-roll bar may act as a torsional spring. The anti-roll bars may be controlled to compensate for some vehicle movements such as body roll, for example from driving around a corner. Body roll can cause the wheels at the side of the vehicle outside the turn to reduce their contact with the road surface. Anti-roll bars may be controlled to counteract this effect and reduce the body roll effect, by transferring at least part of the additional load on the wheels at the side of the vehicle inside the turn to those wheels at the outside, for example by providing a torsional effect to pull the wheels towards the chassis and even out the imbalance in load on the wheels caused by cornering.

A typical suspension system may comprise passive front and rear anti-roll bars provided respectively between the front and rear pairs of wheels of a standard four-wheel vehicle. In a vehicle with an active roll control system, an anti-roll bar 270, 280 may respectively comprise two anti-roll bar ends (273, 274; 283, 284) connected together by a central housing having an actuator 272, 282. The central housing may additionally have one or more of a gearbox, sensors, and dedicated actuator controllers. The actuator 272, 282 acts to provide an actively controlled torque rather than a fixed torsional stiffness provided by passive anti-roll bars. One or more sensors may monitor the movement of the vehicle, and provide the sensed parameters as input to the active roll control system to control the actuator and provide a suitable torque to the anti-roll bar. The two ends of the anti-roll bar (273, 274; 283, 284) may be identical, or may be non-identical.

FIG. 2a shows an example control system 200 for a suspension system a vehicle, communicatively connected to front and rear anti-roll bars 270, 280. The control system 200 comprises a controller 240 which is connected by a communication channel 245 to anti-roll bar controllers 250, 260 configured to respectively control front and rear anti-roll actuators 272, 282. The controller 240 may be the controller 110 of FIG. 1. The controller 240 may comprise one or more of the controllers 110 of FIG. 1. In an example, the controller 240 may be a master controller for an electronic active roll control system in the vehicle. The controller 240 may host a vehicle level control strategy and actuation control for the electronic active roll control system in the vehicle.

The controller 240 may be configured to receive one or more sensor signal 203 from one or more sensors attached to the vehicle. The one or more sensor signals 203 may comprise, for example, a signal from a respective suspension height sensor of the vehicle suspension; a signal from a respective motor position sensor for the anti-roll bar actuators 272, 282; a signal from a respective hub acceleration sensor of the vehicle; and a signal from a respective torque sensor for the anti-roll bar actuators 272, 282. A suspension height sensor may be configured to determine a sensor signal indicative of one or more of a height of a left side and a height of a right side of the vehicle suspension. A motor position sensor may be configured to determine a sensor signal indicative of a position of a respective motor of the anti-roll bar actuators 272, 282. A hub acceleration sensor may be configured to determine a sensor signal indicative of an acceleration of one or more hub of a wheel of the vehicle. A torque sensor may be provide a measure of an existing torque generated in the system, as a result of a target torque demand being requested by the controller.

The controller 240 may be configured to receive one or more communication signals via a communications bus 205. The communications bus 205 may be configured to deliver data to the controller 240 from other subsystems within the vehicle. For example, the communications bus 205 may be configured to communicate a signal indicating a status of one or more modules 210, 220, 230 that are in communicative connection with the controller 240 to the controller 240. In another example, the communications bus 205 may be configured to communicate a command from the controller 240 to the one or more modules 210, 220, 230 that are in communicative connection with the controller 240. The one or more modules 210, 220, 230, are discussed further in relation to FIG. 2b below. Signals transmitted over connections 203 or 245 may alternatively or additionally be transmitted over communications bus 205.

The controller 240 may be configured to generate system demand signals to influence a vehicle's motion via the anti-roll actuators 272, 282. An actuator provided between a front pair of wheels of a vehicle may be called a front actuator. A front active roll control (FARC) module may be electrically connected to the front actuator, and may comprise the controller 250 to control the front actuator 270. Similarly, an actuator provided between a rear pair of wheels of a vehicle may be called a rear actuator. A rear active roll control (RARC) module may be electrically connected to the rear actuator and may comprise a controller 260 to control the rear actuator 280.

The front and rear anti-roll actuators 272, 282 comprises an electric motor which is controllable by the respective anti-roll controller 250, 260. Each of the front and rear anti-roll actuators 272, 282 may be controlled by its own respective anti-roll controller in some examples, or multiple anti-roll actuators may be controlled by a common anti-roll controller in some examples. Each of the anti-roll actuators 272, 282 may be individually controlled in some cases to improve the management of the roll of the body of the vehicle. The front and rear anti-roll actuators 272, 282 may be controlled by a control signal which is generated by the controller 240 may generate and output, through the output channel 245, to the anti-roll bar controllers 250, 260.

The control signal may carry instructions to be implemented by the actuator, for example by providing a torque to apply to the anti-roll bar. For example, as discussed above, when the vehicle is cornering, a control signal may be transmitted to the anti-roll bar controllers 250, 260, which may in turn transmit a control signal via interface 255, 265, so that the front and read anti-roll actuators 272, 282 may mitigate a body roll effect. Similarly, anti-roll bar controllers 250, 260 may transmit measured values from the anti-roll actuators to the controller 240 through output channel 245.

FIG. 2b shows an example control system 200 for a vehicle comprising one or more modules 210, 220, 230, a controller 240 and front and rear anti-roll bars 270, 280. As in FIG. 2a, the control system 200 comprises a controller 240 which is connected by a communication channel 245 to controllers 250, 260 configured to respectively control front and rear anti-roll bar actuators 270; 280. Further, the controller 240 of the control system 200 is in a communicative connection to the one or more modules 210, 220, 230 via a communications bus 205. The one or more modules 210, 220, 230 may be configured to perform functions relating to power supply of the suspension system. Module 210 may be a power control module configured to control a power supply system for the suspension system. Module 220 may be a conversion module configured to convert electrical energy output from a vehicle power supply system. In an example, the conversion module 220 may comprise a DC-DC converter. Module 230 may be a capacitor or supercapacitor module configured to store electrical energy for the suspension system. Together, conversion module 220 and capacitor module 230 may be configured to supply electrical energy to the controllers 250, 260, such that the anti-roll bar actuators 272, 282 can be actuated. FIG. 2b illustrates these modules 210, 220, 230 as individual modules. However, there may be examples whereby components within the modules 210, 220, and 230 are included in a single module.

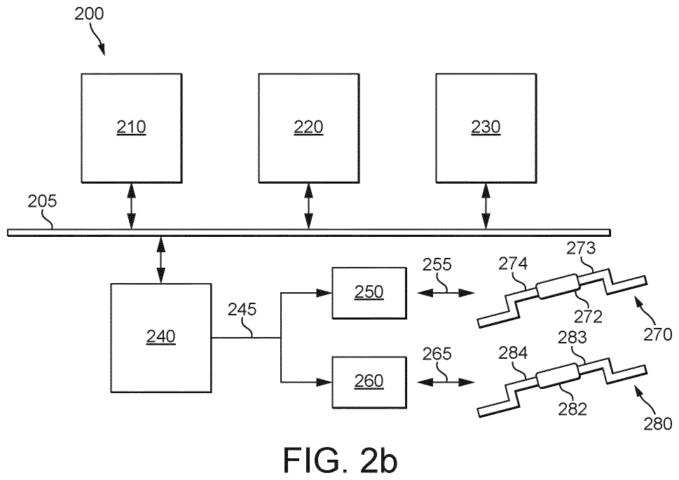

FIG. 3 shows an example torque demand profile 300. The example torque demand profile of FIG. 3 shows an amount of torque, in Newton meters (Nm), to be demanded from the electromechanical actuator, as a function of time. The example torque demand profile comprises a positive and negative torque within first torque limits Q₃ to Q₁, and a positive and negative torque within second torque limits −Q₄ to Q₂. In some examples, positive and negative torque limits are symmetrical about 0 Nm. For example, Q₃=−Q₁, and Q₄=−Q₂.

The example torque demand profile 300 of FIG. 3 begins at time t₁ and conclude at time t₁₈, thus having a torque demand profile duration of t_{d}. Between time t₁ and t₂, the torque demand of the torque demand profile 300 has a magnitude of 0 Nm. Between time t₂ and t₃, the torque demand is increased at a constant rate (i.e. a steady increase) from a torque of 0 Nm to a first positive torque limit Q₁. Between time t₃ and t₄, the torque demand is maintained at the first positive torque limit Q₁. Between time t₄ and t₅, the torque demand is decreased at a constant rate (i.e. a steady decrease) from the first positive torque limit Q₁ to 0 Nm. Between time t₅ and t₆, a torque demand of 0 Nm is maintained. Between time t₆ and t₇, the torque demand is decreased at a constant rate from a torque of 0 Nm to a first negative torque limit Q₃. Between time t₇ and t₈, the torque demand is maintained at the first negative torque limit Q₃. Between time t₈ and t₉, the torque demand is increased at a constant rate from the first negative torque limit Q₃ to 0 Nm. Between time t₉ and t₁₀, the torque demand of 0 Nm is maintained.

Between time t₁₀ and t₁₁, the torque demand is increased at a constant rate from a torque of 0 Nm to a second positive torque limit Q₂. Between time t₁₁ and t₁₂, the torque demand is maintained at the second positive torque limit Q₂. Between time t₁₂ and t₁₃, the torque demand is decreased at a constant rate from the second positive torque limit Q₂ to 0 Nm. Between time t₁₃ and t₁₄, a torque demand of 0 Nm is maintained. Between time t₁₄ and t₁₅, the torque demand is decreased at a constant rate from a torque of 0 Nm to a second negative torque limit Q₄. Between time t₁₅ and t₁₆, the torque demand is maintained at the second negative torque limit Q₄. Between time t₁₆ and t₁₇, the torque demand is increased at a constant rate from the second negative torque limit Q₄ to 0 Nm. Between time t₁₇ and t₁₈, a torque demand of 0 Nm is maintained.

In the example torque demand profile 300 of FIG. 3, the first positive torque limit Q₁ is of lower magnitude than the second positive torque limit Q₂. However, in some examples the first positive torque limit Q₁ may be of greater magnitude than the second positive torque limit Q₂.

In some examples, the rate of increase between time t₂ and t₃ is equal to the rate of decrease between time t₄ and t₅. This is to say, the time elapsed between t₂ and t₃ is the same as the time elapsed between t₄ and t₅. Similarly, the rate of increase between time t₁₀ and t₁₈ is equal to the rate of decrease between time t₁₂ and t₁₃. This is to say, the time elapsed between t₁₀ and t₁₈ is the same as the time elapsed between t₁₂ and t₁₃. In other examples, there may be a square-wave type torque profile demand so that the time taken to increase or decrease the torque demand signal is very small so as to be substantially zero.

In some examples, the time between t₂ and t₃ is equal to the time between t₆ and t₇, the time between t₃ and t₄ is equal to the time between t₇ and t₈, and the time between t₄ and t₅ is equal to the time between t₈ and t₉. This is to say, the torque demand profile between t₂ and t₅ is of the same magnitude as the torque demand profile between tₑ and t₉, but with opposite polarity. Similarly, in some examples, the torque demand profile between t₁₀ and t₁₃ is of the same magnitude as the torque demand profile between t₁₄ and t₁₇, but with opposite polarity.

In some examples, the first torque limits Q₃ to Q₁, and the second torque limits Q₄ to Q₂, may be configurable by a user initiating a diagnostic test on the vehicle. In some examples, the test duration, t_{d}, may be configurable by a user initiating the diagnostic test on the vehicle. In some examples, one or more of the first and second torque limits and the test duration may be configurable only through a software update.

A torque demand signal corresponding to the torque demand profile 300 may be transmitted to the electromechanical actuator system of the vehicle, for example actuators 272, 282 of the vehicle suspension system. Application of torque to the actuators may cause motion of the vehicle. For example, application of torque to the actuators may cause the vehicle to lean to one side or, rock in a sideways motion. In some examples, the torque demand signal may be converted by an actuator controller to a motor speed or motor current that needs to be achieved to deliver the demanded torque.

The torque demand signal may be applied separately to each of the actuators 272, 282. Alternatively, the torque demand signal may be applied simultaneously to each of the actuators 272, 282.

One or more characteristics of the vehicle, in response to the application of the torque demand signal, may be monitored using one or more sensors in the vehicle. For example, a symmetry of deflection of the suspension of the vehicle may be measured in response to a positive and negative torque being applied. The suspension deflection may be measured by one or more sensors arranged on the chassis of the vehicle, for example optical or electroacoustic rangefinders, accelerometers, or the like. In an example, a roll angle or amount of lean of the vehicle may be measured in response to a torque being applied. In an example, a lateral acceleration of the vehicle in response to the application of the torque may be measured.

One or more characteristics of the electromechanical actuator system itself may be measured in response to the application of the torque demand signal. For example, a time taken for the actual torque applied to the actuator to reach a demanded torque level defined by the torque demand profile may be measured. In an example, an amount of rotation in a motor of the electromechanical actuator system may be measured, in response to the applied torque demand profile. In examples, one or more electrical characteristics of the electromechanical system may be measured. For example, one or more of a current or voltage required in order to achieve the demanded torque level may be measured.

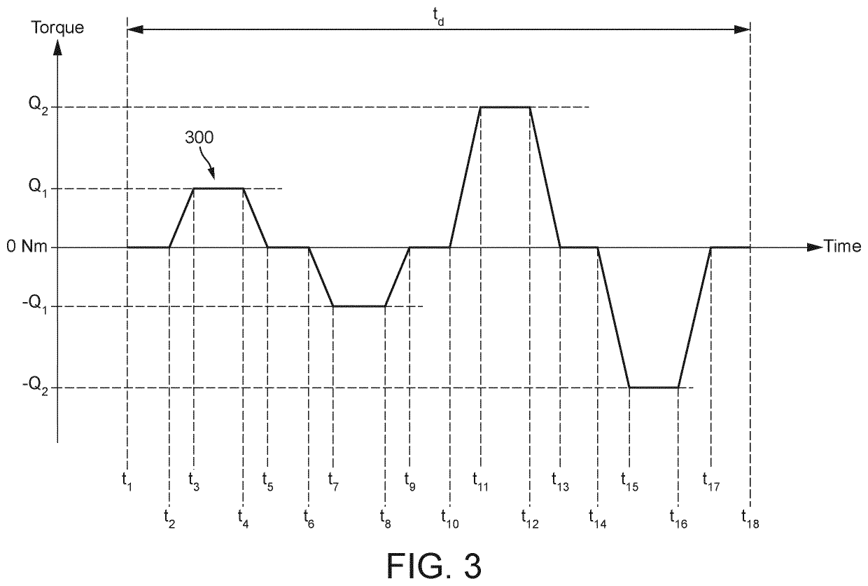

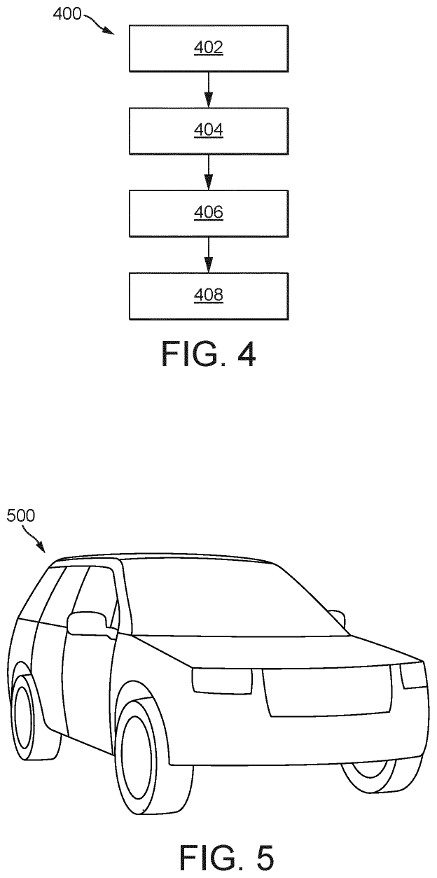

FIG. 4 illustrates an example method of testing system response in an electromechanical actuator system of a vehicle 500, such as the vehicle 500 illustrated in FIG. 5. In particular, the method is a method of testing the response of the vehicle and the electromechanical actuator system to a torque demand profile applied to an actuator of the electromechanical actuator system. The method 400 may be performed by the system 100 illustrated in FIG. 1. The memory 130 may comprise computer readable instructions which, when executed by the processor 120 of any diagnostic apparatus disclosed herein, perform the method 400.

The method 400 comprises: generating a torque demand signal 402; transmitting the torque demand signal to the electromechanical actuator system 404; recording a suspension characteristic in response to the application of said torque demand signal 406; and outputting the recorded suspension characteristic 408.

In some examples, verification of satisfaction of one or more safety preconditions may be required prior to transmitting the torque demand signal. These safety preconditions may comprise one or more of: ensuring that a system automotive safety level (ASIL) is or can be maintained throughout the duration of the diagnostic test; verifying that the vehicle is in a stationary state; verifying that there are no fault conditions in the vehicle (either current or recently recorded); and verifying that a provided security credential of a user initiating the test meets a security authorisation level. In some examples, application of the torque demand signal to the electromechanical actuator system may be stopped if the duration of the diagnostic test exceeds an expected or predetermined time limit. Accordingly, system and vehicle safety is assured by one or more of: preventing access to the test by unauthorized users, as security access is required to place the controller (for example, a controller of the chassis control module) in the correct operational state to run the test; not causing active torque to be delivered by the system if any faults are present; not starting the test if vehicle level conditions are not met (for example the vehicle being stationary, the engine running); and aborting the diagnostic test if the test does not conclude within an expected time period. The determining whether any faults are present may comprise identifying faults relating to the electromechanical actuator system.

In some examples, the method may further comprise comparing one or more recorded suspension characteristics to a predetermined threshold or range, and recording or outputting a fault indication if the one or more suspension characteristics are exceed the predetermined threshold, fail to meet the predetermined threshold, or are outside of the predetermined range.

In some examples, the method may further comprise measuring to ensure the electronic actuator system delivers torque within acceptable limits in terms of accuracy and response times. Historic data of performance and response times may be stored in order to monitor for any possible degradation of the electronic actuator system, or parts thereof.

The illustration of a particular order to the blocks of the method of FIG. 4 does not necessarily imply that there is a required or preferred order for the blocks and the order and arrangement of the blocks may be varied. Furthermore, it may be possible for some steps to be omitted or added in other examples.

This disclosure also includes computer software that, when executed, is configured to perform any method disclosed herein, such as that illustrated in FIG. 4. The computer software may be stored on a computer readable medium, and may be tangibly stored. Thus, a set of computer-readable instructions may be provided which, when executed, cause said controller 110 or control system 100 to implement any method described herein. The set of instructions may be embedded in one or more electronic processors, or alternatively, the set of instructions could be provided as software to be executed by one or more electronic processor(s). For example, a first controller may be implemented in software run on one or more electronic processors, and one or more other controllers may also be implemented in software run on one or more electronic processors, or, optionally, on the same one or more processors as the first controller. It will be appreciated, however, that other arrangements are also useful, and therefore, the present disclosure is not intended to be limited to any particular arrangement. In any event, the set of instructions described above may be embedded in a computer-readable storage medium (for example, a non-transitory computer-readable storage medium) that may comprise any mechanism for storing information in a form readable by a machine or electronic processors/computational device, including, without limitation: a magnetic storage medium (for example, floppy diskette); optical storage medium (for example, CD-ROM); magneto optical storage medium; read only memory (ROM); random access memory (RAM); erasable programmable memory (for example, EPROM and EEPROM); flash memory; or electrical or other types of medium for storing such information/instructions.

FIG. 5 illustrates a vehicle 500 according to an embodiment of the present invention. The vehicle 500 comprises a control system 100 as illustrated in FIG. 1. The vehicle 500 in the present embodiment is an automobile, such as a wheeled vehicle, but it will be understood that the control system, active suspension system and diagnostic apparatus may be used in other types of vehicle.

The diagnostic apparatuses and methods described herein enable a user in a service or manufacturing environment to identify interface, wiring or mechanical issues, for example, with the electronic actuator system, or parts thereof. The diagnostic apparatuses and methods described herein may enable verification of correct system integration of the electronic actuator system, due to exciting functionality in the constituent modules.

The diagnostic apparatuses and methods described herein may allow for one or more of: on demand performance and health checks of the electronic actuator system; individual axle or actuator input excitation; and a repeatable electronic actuator system input excitation. Furthermore, the diagnostic apparatuses and methods described herein may help to ensure electronic actuator system functional safety is met prior to test execution. The diagnostic apparatuses and methods described herein may allow for one or more of: objective system response assessments throughout the vehicle lifetime in order to quantify any degradation of the electronic actuator system or parts thereof; investigation of mechanical degradation of an actuator of the electronic actuator system; and accurate measurement and storage of the performance of the system to identify degradation over time, or any imbalance between the front and rear axles which would affect the dynamic behaviour of the vehicle.

It will be appreciated that various changes and modifications can be made to the present invention without departing from the scope of the present application.

As used here, ‘connected’ means ‘electrically interconnected’ either directly or indirectly. Electrical interconnection does not have to be galvanic. Where the control system is concerned, connected means operably coupled to the extent that messages are transmitted and received via the appropriate communication means. In the present disclosure, the term ‘current’ means electrical current. The term ‘voltage’ means potential difference.

Whilst endeavouring in the foregoing specification to draw attention to those features believed to be of particular importance it should be understood that the Applicant claims protection in respect of any patentable feature or combination of features hereinbefore referred to and/or shown in the drawings whether or not particular emphasis has been placed thereon.

1-15. (canceled)

16. A diagnostic apparatus for use in testing an electromechanical actuator system of a vehicle, the diagnostic apparatus comprising one or more controllers, the diagnostic apparatus configured to:
generate a torque demand signal corresponding to a torque demand profile 300, the torque demand profile configured to cause actuators of the electromechanical actuator system to modify a suspension of the vehicle;
transmit the torque demand signal to the electromechanical actuator system of the vehicle;
record a suspension characteristic of the vehicle in response to application of the torque demand signal; and
output the recorded suspension characteristic of the vehicle.

17. The diagnostic apparatus of claim 16, wherein the torque demand profile comprises:
a positive torque and a negative torque within first torque limits; and
a positive torque and a negative torque within second torque limits.

18. The diagnostic apparatus of claim 16, wherein the torque demand profile 300 comprises one or more of:
a steady increase in torque to a positive torque limit;
a constant torque at the positive torque limit;
a steady decrease in torque to zero;
a steady decrease in torque to a negative torque limit;
a constant torque at the negative torque limit; and
a steady increase in torque to zero.

19. The diagnostic apparatus of claim 16, wherein recording the suspension characteristic of the vehicle comprises monitoring one or more of:
a symmetry of deflection of the suspension at both sides of the vehicle;
a roll angle of the vehicle;
an amount of lean of the vehicle; and
a lateral acceleration of the vehicle.

20. The diagnostic apparatus of claim 16, configured to:
record one or more characteristics of the electromechanical actuator system; and
output the recorded one or more characteristics of the electromechanical actuator system.

21. The diagnostic apparatus of claim 20, wherein recording one or more characteristics of the electromechanical actuator system comprises receiving one or more of:
a time taken for torque to reach a demanded torque level; and
a physical rotation of a motor of the electromechanical actuator system.

22. The diagnostic apparatus of claim 20, wherein recording one or more characteristics of the electromechanical actuator system comprises receiving one or more of a current and voltage applied to the electromechanical actuator system to achieve the torque demand profile.

23. The diagnostic apparatus of claim 16, wherein the diagnostic apparatus is configured to, prior to transmitting the torque demand signal, verify that one or more safety preconditions are met.

24. The diagnostic apparatus of claim 23, wherein verifying that the one or more safety preconditions are met comprises one or more of:
ensuring that a system automotive safety integrity level, ASIL, is maintained;
verifying that the vehicle is in a stationary state;
verifying that there are no fault conditions in the vehicle; and
verifying if a provided security credential meets a security authorization level.

25. The diagnostic apparatus of claim 16, wherein the diagnostic apparatus is configured to:
identify that a recorded characteristic of the electromechanical actuator is outside of a predetermined range; and
output a fault indication.

26. The diagnostic apparatus of claim 16, configured to stop application of the torque demand signal to the electromechanical actuator system if a test duration exceeds an expected time period.

27. A system, comprising:
the diagnostic apparatus according to claim 16; and
the electromechanical actuator system of the vehicle.

28. A vehicle comprising a diagnostic apparatus according to claim 16.

29. A method comprising:
generating a torque demand signal corresponding to a torque demand profile, the torque demand profile configured to cause actuators of an electromechanical actuator system of a vehicle to modify a suspension of the vehicle;
transmitting the torque demand signal to the electromechanical actuator system of the vehicle;
recording a suspension characteristic of the vehicle in response to application of the torque demand signal; and
outputting the recorded suspension characteristic of the vehicle.

30. Computer readable instructions arranged to perform a method according to claim 29.
